(19) United States
(12) Patent Application Publication
(10) Pub. No.: US 2006/0146250 A1
(43) Pub. Date: Jul. 6, 2006

(54) LCD DEVICE HAVING ADJUSTABLE VIEWING ANGLES

(76) Inventors: Ming-Chou WU, Nan-Tou Hsien (TW); Yung-Lun Lin, I-Lan Hsien (TW); Meng-Chang Tsai, Chia-I City (TW); Po-Lun Chen, Chia-I City (TW)

Correspondence Address: NORTH AMERICA INTELLECTUAL PROPERTY CORPORATION, P.O. BOX 506, MERRIFIELD, VA, 22116, US

(21) Appl. No.: 11/161,175

(22) Filed: Jul. 26, 2005

(30) Foreign Application Priority Data
Jan. 6, 2005 (TW) 094100369

(51) Int. Cl. G02F 1/1343

(52) U.S. Cl. 349/141

(57) ABSTRACT

An LCD device having adjustable viewing angles includes a first substrate, a second substrate, and a liquid crystal layer disposed between the first substrate and the second substrate. The first substrate has a first common electrode. The second substrate has a pixel electrode, a second common electrode, and an insulating layer formed between the pixel electrode and the second common electrode. While in a narrow viewing angle mode of the LCD device, a driving voltage is applied to the pixel electrode, the first common electrode is grounded, and the second common electrode is floating. While in a wide viewing angle mode of the LCD device, a driving voltage is applied to the pixel electrode, the second common electrode is grounded, and the first common electrode is floating.

### BACKGROUND OF INVENTION

1. Field of the Invention

The present invention relates to an LCD device having adjustable viewing angles, and more particularly, to an LCD device capable of switching a wide viewing angle mode to a narrow viewing angle mode or switching a narrow viewing mode to a wide viewing angle mode.

2. Description of the Prior Art

With an increase in the LCD sizes, limitations in viewing angles of conventional twisted nematic (TN) type LCDs have been observed. To remove the limitations in the viewing angles and allow the users to observe undistorted images at various viewing angles, viewing angle expanding technology has been researched. For example, the use of a viewing angle compensation film, forming different pre-tilt angle directions in a pixel region, or in-plane switching (IPS) type LCDs are proposed to expand the viewing angles of LCDs.

Although the viewing angle expanding technology is essential to increase a contrast of LCD, the viewing angles are limited in some LCD applications so as to allow the user to see the image only at specific angles. For example, for security or privacy, when the user operates the automated teller machine in the bank or the notebook computer in public, it is desirable to use the viewing angle narrowing technology to allow the user to see the useful information (clear image) from the front of the display and prevent the others aside of the user from seeing the image:
U.S. Pat. No. 6,445,434 B2 discloses a method to narrow viewing angles, which divides an alignment layer into a plurality of specific regions and an orientation (rubbing) direction of adjacent regions is different from one another. Since each of the different orientation directions results in different gray level reverse, the image observed at the large viewing angle becomes unclear and indistinct. In addition, U.S. Pat. Nos. 6,239,853 B1 and 6,398,370 B1 disclose to achieve narrow viewing angles utilizing a light filter attached on LCD so as to allow specific polarized light to pass through the light filter.

The viewing angle narrowing technology satisfies the concern of security and privacy, however, the range of viewing angles and the convenience for the use of LCD are sacrificed. To provide more choices to the user, U.S. Pat. No. 5,877,829 provides an LCD capable of adjusting viewing angles. The LCD has two optical elements installed on the front and the back of the LCD so as to respectively control the direction of light going out from or entering the LCD. The optical element close to the backlight source is specifically used to control the direction of light entering the LCD, and the optical element close to the user is in fact another liquid crystal layer and is used to adjust the passing rate (or the diffusing rate) of light to achieve the goal of adjusting viewing angles.

Although the above-mentioned LCD allows the user to adjust the passing rate of light according to his desire for viewing angles, the use of the extra liquid crystal layer increases the difficulty in manufacturing and operating the LCD. Therefore, how to reduce the complexity in the structure of LCD and provide a convenient method to adjust the viewing angles of LCD are important issues.

### SUMMARY OF INVENTION

It is an object of the present invention to provide an LCD device having viewing angles adjustable between a wide viewing angle mode and a narrow viewing angle mode.

According to one embodiment of the present invention, the LCD device is composed of a first substrate, a second substrate, and a liquid crystal layer disposed between the first substrate and the second substrate. The first substrate has a first common electrode. The second substrate has a pixel electrode, a second common electrode, and an insulating layer formed between the pixel electrode and the second common electrode. While in a narrow viewing angle mode of the LCD device, a driving voltage is supplied to the pixel electrode, the first common electrode is grounded, and the second common electrode is floating. While in a wide viewing angle mode of the LCD device, a driving voltage is supplied to the pixel electrode, the second common electrode is grounded, and the first common electrode is floating.

It is an advantage of the present invention that the first common electrode and the second common electrode can be switched to conveniently choose the narrow viewing angle mode or the wide viewing angle mode. In comparison with the prior art LCD having two liquid crystal layers, the LCD device of the present invention particularly provides the advantages of simplifying the LCD structure and reducing the manufacturing costs to facilitate the development and the application of the LCD device.

These and other objects of the claimed invention will be apparent to those of ordinary skill in the art with reference to the following detailed description of the preferred embodiments illustrated in the various drawings.

### BRIEF DESCRIPTION OF DRAWINGS

FIG. 1 is a cross-sectional diagram of an LCD device having adjustable viewing angles according to the present invention;

FIG. 2 is a schematic diagram of a polarizing direction and a rubbing direction of an LCD device according to the present invention;

FIG. 3 is a schematic diagram of a polarizing direction and a rubbing direction of an LCD device according to another embodiment of the present invention;

FIG. 4 and FIG. 5 are schematic diagrams of a bright state and a dark state for an LCD device operated at a narrow viewing angle mode according to the present invention;

FIG. 6 and FIG. 7 are schematic diagrams of a bright state and a dark state for an LCD device operated at a wide viewing angle mode according to the present invention; and

FIG. 8 is a schematic diagram of a rubbing direction arrangement of an LCD device according to another embodiment of the present invention.

### DETAILED DESCRIPTION

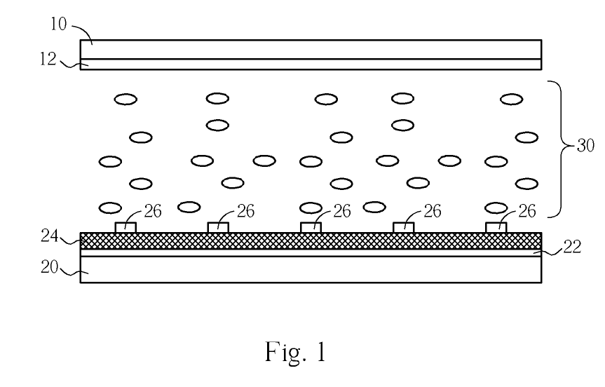

Referring to FIG. 1, FIG. 1 is a cross-sectional diagram of an LCD device having adjustable viewing angles according to the present invention. As shown in FIG. 1, an LCD device has two parallel substrates 10 and 20, and a liquid crystal layer 30 is filled in a gap between the substrate 10 and the substrate 20. In a preferred embodiment of the present invention, the substrate 10 is a color filter substrate with a plurality of red, green, and blue color filters, and a black matrix (not shown in FIG. 1) is also formed on the substrate 10. Light penetrates through the substrate 10 to produce the three primary colors of red, green, and blue to compose colorful images. The substrate 20 is a thin-film transistor substrate with TFT array, capacitors, scan lines and signal lines. The substrate 20 is used to drive pixel electrodes and rotation of liquid crystal. In other embodiments of the present invention, the substrate 20 can be a color-filter-on-array (COA) substrate or an array-on-color-filter (AOC) substrate so that the substrate 20 has the elements of color filters and TFT array. In this case, the substrate 10 can be a glass or plastic substrate without color filters thereon.

In addition, a common electrode 12 is formed on a surface of the substrate 10, and a pixel electrode 22, an insulating layer 24 covering the pixel electrode 22, and a common electrode 26 are formed on a surface of the substrate 20. In a preferred embodiment of the present invention, the common electrode 12, the pixel electrode 22, and the common electrode 26 are transparent electrodes made of ITO or IZO. The insulating layer 24 is a transparent passivation layer made of silicon dioxide, silicon nitride or organic materials. Since the LCD device of the present invention provides an IPS-like wide viewing angle mode, the common electrode 26 is preferably composed of a plurality of protrusions arranged along a first direction, and two adjacent common electrodes 26 are separated from each other with a predetermined distance so as to expose portions of the surface of the pixel electrode 22.

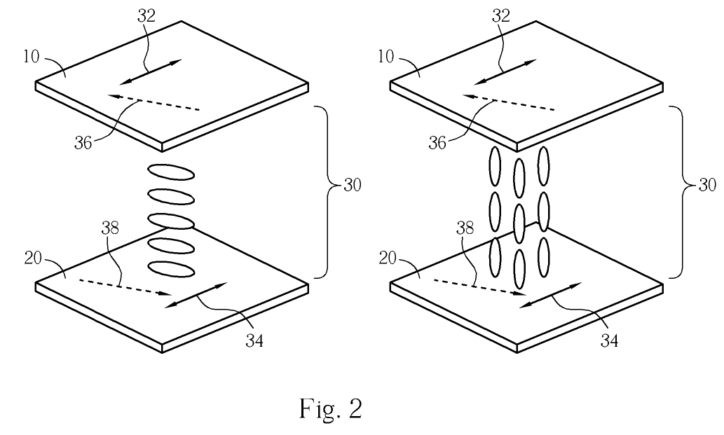

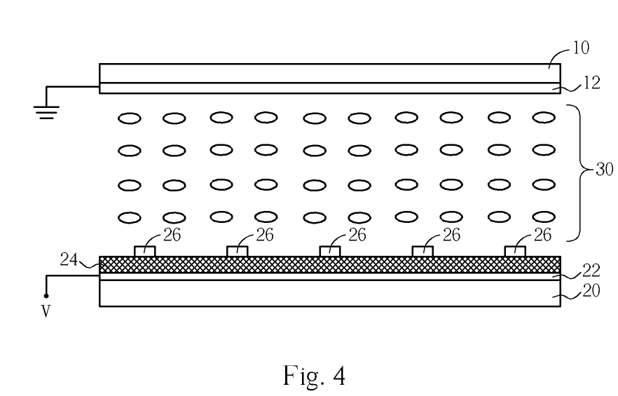

Referring to FIG. 2, FIG. 2 is a schematic diagram of a polarizing direction and a rubbing direction of an LCD device according to the present invention. The left portion in FIG. 2 illustrates the rotation of liquid crystal in the LCD device at a dark state, and the right portion in FIG. 2 illustrates the rotation of liquid crystal in the LCD device at a bright state. The operation condition of the dark state and the bright state under the different viewing angle modes are illustrated in FIGS. 4-7 and will be introduced later. As shown in FIG. 2, the substrate 10 is configured to define a polarizing direction 32 indicated by a bold line, and a rubbing direction 36 indicated by a dotted line. The substrate 20 is configured to define a polarizing direction 34 indicated by a bold line, and a rubbing direction 38 indicated by a dotted line. Preferably, the polarizing direction 32 is parallel to the polarizing direction 34; the rubbing direction 36 and the rubbing direction 38 are parallel but pointing toward reverse directions; an angle between the rubbing direction 36 and the polarizing direction 32 ranges between 0 and 90 degrees; and an angle between the rubbing direction 38 and the polarizing direction 34 ranges between 0 and 90 degrees.

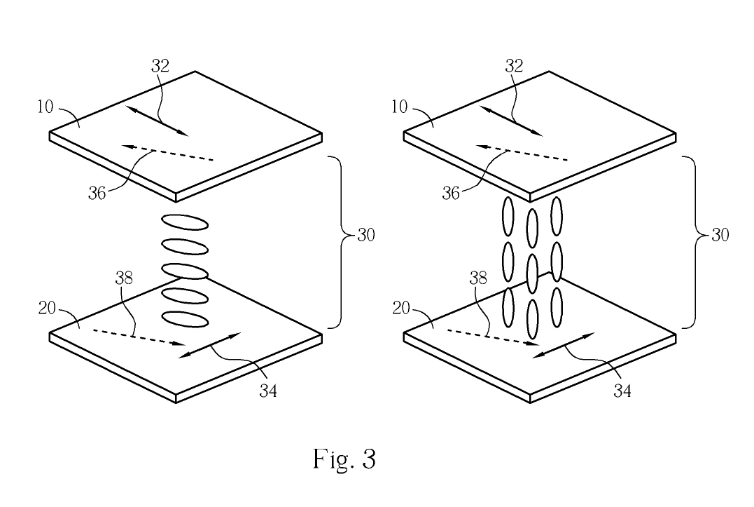

Referring to FIG. 3, FIG. 3 is a schematic diagram of a polarizing direction and a rubbing direction of an LCD device according to another embodiment of the present invention. The left portion in FIG. 3 illustrates the rotation of liquid crystal in the LCD device at a bright state, and the right portion in FIG. 3 illustrates the rotation of liquid crystal in the LCD device at a dark state. The operation condition of the dark state and the bright state under the different viewing angle modes are illustrated in FIGS. 4-7 and will be introduced later. The difference between this embodiment and the embodiment shown in FIG. 2 is that, the polarizing direction 32 and the polarizing direction 34 are perpendicular to each other as shown in FIG. 3, but the polarizing direction 32 and the polarizing direction 34 are parallel to each other as shown in FIG. 2. The difference between the two embodiments results in different rotation conditions of liquid crystal while at the bright state and the dark state.

The narrow viewing angle mode provided by the present invention is an inverse viewing angle mode, which produces serious difference in optical characteristics, such as gray level reverse, at large viewing angles. As a result, the image observed at the large viewing angles becomes unclear and indistinct. To approach the inverse viewing angle mode, the common electrode 12 and the pixel electrode 22 have to provide a vertical electric field therebetween. For example, a driving voltage V is supplied to the pixel electrode 22 and the common electrode 26 is floating so as to control the rotation of liquid crystal.

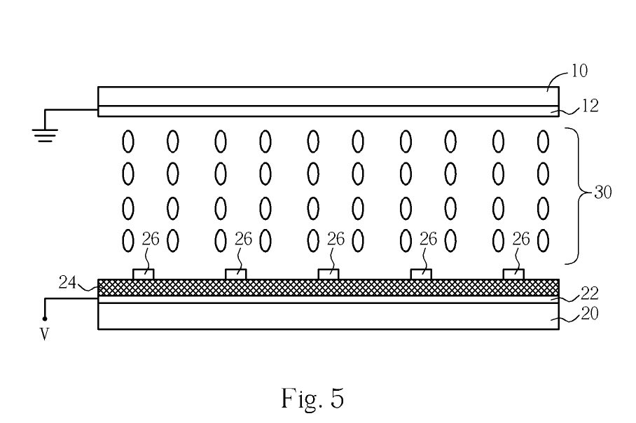

Referring to FIG. 4 and FIG. 5, FIG. 4 and FIG. 5 are schematic diagrams of a bright state and a dark state for an LCD device operated at a narrow viewing angle mode according to the present invention. As shown in FIG. 4, when no electric field is supplied, liquid crystal molecules in the liquid crystal layer 30 are aligned along the rubbing directions 36 and 38. In addition, the angle between the rubbing direction 36 and the polarizing direction 32 can be controlled to make the rubbing direction 36 not parallel to the polarizing direction 32, and the angle between the rubbing direction 38 and the polarizing direction 34 can be controlled to make the rubbing direction 38 not parallel to the polarizing direction 34. The non-parallel directions 36, 32 and the non-parallel directions 38, 34 result in phase retardation to change the polarization of light. When the polarizing direction 32 is parallel to the polarizing direction 34 (as the embodiment illustrated in FIG. 2), light passing through the substrate 20 and the liquid crystal layer 30 cannot pass a polarizer (not shown) attached to the substrate 10. As a result, the user in front of the substrate 10 cannot observe light being emitted from the LCD device, and this condition is called the dark state of the LCD device. As shown in FIG. 5, positive liquid crystal in the liquid crystal layer 30 intends to be vertically aligned along a supplied electric field. When the polarizing direction 32 is parallel to the polarizing direction 34 (as the embodiment illustrated in FIG. 2), the orientation direction of liquid crystal is perpendicular to the polarizing directions 32 and 34. Light passing through the substrate 20 and the liquid crystal layer 30 will not produce phase retardation and polarization variation. As a result, the user in front of the substrate can observe light being emitted from the LCD device, and this condition is called the bright state of the LCD device. However, when the polarizing direction 32 is perpendicular to the polarizing direction 34 (as the embodiment illustrated in FIG. 3), the dark state and the bright state are contrary to the states described above. The condition shown in FIG. 4 is called the bright state, and the condition shown in FIG. 5 is called the dark state when the polarizing direction 32 is perpendicular to the polarizing direction 34. Under the arrangement of the polarizing directions 32, 34 and the rubbing directions 36, 38, and the control of the pre-tilt angle of liquid crystal and the distribution of the electric field, the user can recognize the image only from the front of the LCD device. The serious gray level reverse at large viewing angles disables the user from recognizing the image, so as to provide the narrow viewing angle mode or the called inverse viewing angle mode.

The wide viewing angle mode of the LCD device utilizes the common electrode 26 and the pixel electrode 22 to provide a lateral electric field. For example, a driving voltage V is supplied to the pixel electrode 22, the common electrode 12 is floating, and the common electrode 26 is grounded so as to control the rotation of liquid crystal.

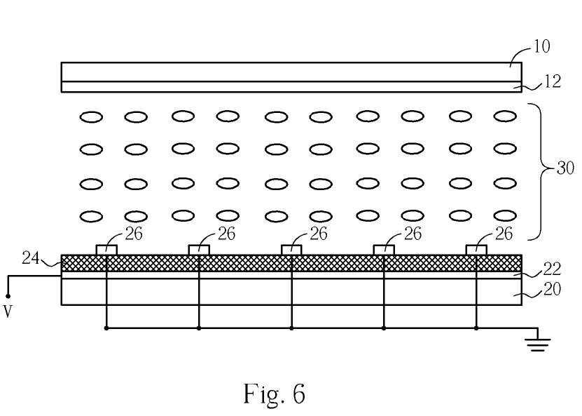

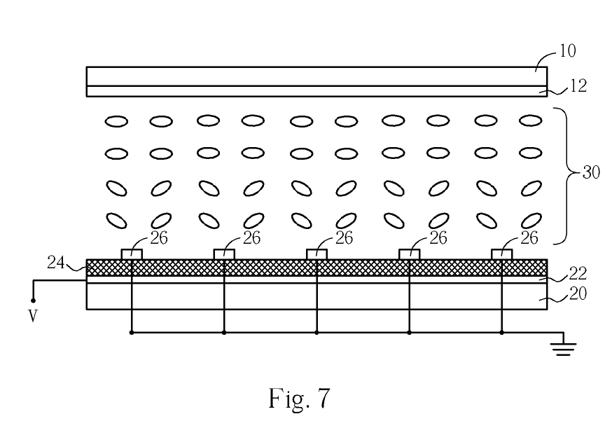

Referring to FIG. 6 and FIG. 7, FIG. 6 and FIG. 7 are schematic diagrams of a bright state and a dark state for an LCD device operated at a wide viewing angle mode according to the present invention. As shown in FIG. 6, when no electric field is supplied, liquid crystal molecules in the liquid crystal layer 30 are aligned along the rubbing directions 36 and 38. In addition, the angle between the rubbing direction 36 and the polarizing direction 32 can be controlled to make the rubbing direction 36 not parallel to the polarizing direction 32, and the angle between the rubbing direction 38 and the polarizing direction 34 can be controlled to make the rubbing direction 38 not parallel to the polarizing direction 34. The non-parallel directions 36, 32 and the non-parallel directions 38, 34 result in phase retardation to change the polarization of light. When the polarizing direction 32 is parallel to the polarizing direction 34 (as the embodiment illustrated in FIG. 2), light passing through the substrate 20 and the liquid crystal layer 30 cannot pass a polarizer (not shown) attached to the substrate 10. As a result, the user in front of the substrate 10 cannot observe light being emitted from the LCD device, and this condition is called the dark state of the LCD device. As shown in FIG. 7, positive liquid crystal in the liquid crystal layer 30 intends to be laterally aligned along a supplied electric field. When the polarizing direction 32 is parallel to the polarizing direction 34 (as the embodiment illustrated in FIG. 2), the orientation direction of liquid crystal is parallel to the polarizing direction 32 or the polarizing direction 34. Light passing through the substrate 20 and the liquid crystal layer 30 will not produce phase retardation and polarization variation. As a result, the user in front of the substrate 10 can observe light being emitted from the LCD device, and this condition is called the bright state of the LCD device. However, when the polarizing direction 32 is perpendicular to the polarizing direction 34 (as the embodiment illustrated in FIG. 3), the dark state and the bright state are contrary to the states described above. The condition shown in FIG. 6 is called the bright state, and the condition shown in FIG. 7 is called the dark state when the polarizing direction 32 is perpendicular to the polarizing direction 34. Since the common electrode 26 provides the IPS-like electrode architecture to change the orientation of liquid crystal and provides the IPS-like wide viewing angle mode, the user can recognize the clear and undistorted image from various viewing angles.

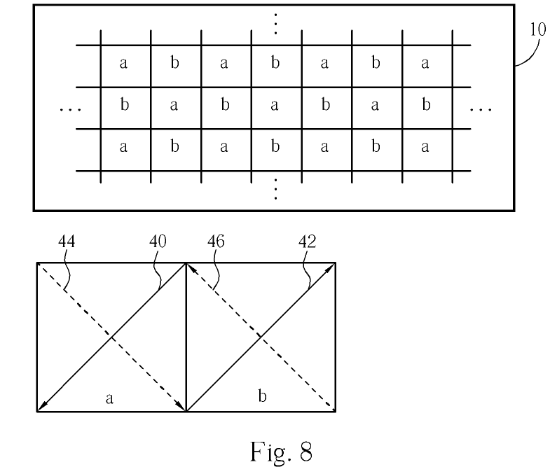

In addition to the arrangement of the polarizing directions and the rubbing directions described in FIG. 2 and FIG. 3, the present invention further provides the arrangement of polarizing directions and rubbing directions similar to a twisted nematic mode in other embodiments of the present invention. Referring to FIG. 8, FIG. 8 is a schematic diagram of a rubbing direction arrangement of an LCD device according to another embodiment of the present invention. As shown in FIG. 8, the surface of the substrate 10 is divided into a plurality of regions a and b. Each region a provides a different rubbing direction from the neighboring regions b. For example, a rubbing direction 40 of the region a is parallel to a rubbing direction 42 of the region b, but the rubbing direction 40 is reverse to the rubbing direction 42. In addition, a polarizing direction of the substrate is parallel to the rubbing directions 40 and 42. Similarly, the surface of the substrate 20 is divided into a plurality of regions a and b. Each region a provides a different rubbing direction from the neighboring regions b. For example, a rubbing direction 44 of the region a is parallel to a rubbing direction 46 of the region b, but the rubbing direction 44 is reverse to the rubbing direction 46. In addition, a polarizing direction of the substrate 20 is parallel to the rubbing directions 44 and 46. According to the theory of the twisted nematic mode, the polarizing direction of the substrate 10 is perpendicular to the polarizing direction of the substrate 20, and the rubbing directions 40, 42 of the substrate 10 are perpendicular to the rubbing directions 44, 46. Therefore, the present invention can apply the arrangement of the polarizing directions and the rubbing directions similar to the twisted nematic mode to the electrode structure shown in FIG. 1, and switch the voltages of the common electrode 12 and the common electrode 26 to achieve the advantages of adjusting the viewing angles between the wide viewing angle mode and the narrow viewing angle mode.

In contrast to the prior art LCD device merely providing wide viewing angles or narrow viewing angles, the present invention can switch the voltages supplied to the common electrodes on the two substrates to select the wide viewing angle mode or the narrow viewing angle mode. It is achievable to install a button on the outer frame of the LCD device and electrically connect the button to the switching circuits to control the voltages supplied to the common electrodes. Therefore, the user can easily use the button to select the wide viewing angle mode or the narrow viewing angle mode according to his choice. In contrast to the prior art LCD device having two liquid crystal layers to adjust the viewing angles, the present invention particularly provides the advantages of simplifying the LCD structure and reducing the manufacturing costs to facilitate the development and the application of the LCD device.

Those skilled in the art will readily observe that numerous modifications and alterations of the device may be made while utilizing the teachings of the invention.

What is claimed is:

1. An LCD device having adjustable viewing angles, comprising:
a first substrate having a first common electrode formed thereon;
a second substrate parallel to the first substrate, the second substrate comprising a pixel electrode, a second common electrode, and an insulating layer positioned between the pixel electrode and the second common electrode; and
a liquid crystal layer disposed between the first substrate and the second substrate;
wherein while in a narrow viewing angle mode of the LCD device, a driving voltage is applied to the pixel electrode, the first common electrode is grounded, and the second common electrode is floating; while in a wide viewing angle mode of the LCD device, a driving voltage is applied to the pixel electrode, the second common electrode is grounded, and the first common electrode is floating.

2. The LCD device of claim 1, wherein the first substrate comprises a color filter substrate.

3. The LCD device of claim 1, wherein the second substrate comprises a thin-film transistor substrate.

4. The LCD device of claim 1, wherein the second common electrode comprises a plurality of parallel protrusions.

5. The LCD device of claim 1, wherein the first substrate is configured to define a first polarizing direction, the second substrate is configured to define a second polarizing direction, and the first polarizing direction is parallel to the second polarizing direction.

6. The LCD device of claim 5, wherein the first substrate is configured to define a first rubbing direction, the second substrate is configured to define a second rubbing direction, and the first rubbing direction is parallel to the second rubbing direction.

7. The LCD device of claim 6, wherein the angle between the first rubbing direction and the first polarizing direction ranges from 0 to 90 degrees.

8. The LCD device of claim 1, wherein the first common electrode, the second common electrode, and the pixel electrode are transparent electrodes.

9. The LCD device of claim 1, wherein the first substrate is configured to define a first polarizing direction, the second substrate is configured to define a second polarizing direction, and the first polarizing direction is perpendicular to the second polarizing direction.

10. The LCD device of claim 9, wherein the first substrate is configured to define a first rubbing direction, and the first rubbing direction is parallel to the first polarizing direction.

11. The LCD device of claim 9, wherein the second substrate is configured to define a second rubbing direction, and the second rubbing direction is parallel to the second polarizing direction.

12. The LCD device of claim 1, wherein the wide viewing angle mode comprises an in-plane switch mode.

13. The LCD device of claim 1, wherein the narrow viewing angle mode comprises an inverse viewing angle mode.

14. The LCD device of claim 1, wherein the narrow viewing angle mode comprises a twisted nematic mode.

15. An LCD device having adjustable viewing angles, comprising:
a first substrate having a first common electrode formed thereon;
a second substrate parallel to the first substrate, the second substrate comprising a pixel electrode, and a second common electrode positioned above the pixel electrode, the second common electrode comprising a plurality of protrusions arranged along a first direction, each of the protrusions being separated from the adjacent protrusions by a predetermined distance; and
a liquid crystal layer disposed between the first substrate and the second substrate;
wherein while in a narrow viewing angle mode of the LCD device, a vertical electric field is applied between the first common electrode and the pixel electrode to drive liquid crystal molecules in the liquid crystal layer; while in a wide viewing angle mode of the LCD device, a lateral electric field is provided by the second common electrode and the pixel electrode to drive the liquid crystal molecules in the liquid crystal layer.

16. The LCD device of claim 15, wherein the first substrate comprises a color filter substrate.

17. The LCD device of claim 15, wherein the second substrate comprises a thin-film transistor substrate.

18. The LCD device of claim 15, further comprising an insulating layer positioned between the pixel electrode and the second common electrode.

19. The LCD device of claim 15, wherein the first substrate is configured to define a first polarizing direction, the second substrate is configured to define a second polarizing direction, and the first polarizing direction is parallel to the second polarizing direction.

20. The LCD device of claim 15, wherein the first substrate is configured to define a first polarizing direction, the second substrate is configured to define a second polarizing direction, and the first polarizing direction is perpendicular to the second polarizing direction.
